(19) United States
(12) Patent Application Publication
(10) Pub. No.: US 2025/0126466 A1
(43) Pub. Date: Apr. 17, 2025

(54) ERROR MESSAGE GENERATION AND PROCESSING

(71) Applicant: Nokia Technologies Oy, Espoo (FI)

(72) Inventors: Anja JERICHOW, Munich (DE); Horst Thomas Belling, Munich (DE); Bruno Landais, Lannion (FR)

(21) Appl. No.: 18/816,720

(22) Filed: Aug. 27, 2024

(30) Foreign Application Priority Data
Oct. 11, 2023 (GB) 2315563.3

(51) Int. Cl. H04W 12/037; H04W 24/08

(52) U.S. Cl. CPC H04W 12/037; H04W 24/08

(57) ABSTRACT

There are provided measures for error message generation and processing. Such measures exemplarily comprise, at a first network entity associated with a first network roaming interconnected with a second network, receiving a message indicative of a roaming service related error, wherein said message includes first error cause information related to said roaming service related error and addressed to said first network entity, and deciding on further handling of said message based on said first error cause information.

### FIELD

Various example embodiments relate to error message generation and processing. More specifically, various example embodiments exemplarily relate to measures (including methods, apparatuses and computer program products) for realizing error message generation and processing in particular in network deployments enabling roaming between connected networks.

### BACKGROUND

The present specification generally relates to network deployments enabling roaming between connected networks.

Roaming and interconnect services are important parts of the mobile ecosystem.

Heretofore, security edge protection proxies (SEPP) are provided. A SEPP is used as egress and ingress point for service based messages between 3^{rd} Generation Partnership Project (3GPP) 5^{th} Generation core (5GC) networks.

The internetwork interconnect allows secure communication between service-consuming and a service-producing network functions (NF) in different public land mobile networks (PLMN).

Security is enabled by the SEPPs of both networks, henceforth called cSEPP (on the service-consuming side) and pSEPP (on the service-producing side), respectively.

The SEPPs enforce protection policies regarding application layer security, thereby ensuring integrity and confidentiality protection for those elements to be protected. The SEPP is a non-transparent proxy that supports message filtering and policing on inter-PLMN control plane interfaces as well as topology hiding for the 5^{th} Generation (5G) stand-alone (SA) roaming and interconnect.

The roaming services infrastructure provided by the mobile operator to its subscribers typically utilizes third parties. Internet protocol (IP) interconnect exchange (IPX), roaming hub (RH), as well as roaming value-added service (RVAS) providers make available roaming services to the mobile network operator (MNO) with efficiency and scalability. IPX and RH are examples of roaming intermediaries (RI) which are entities that provide roaming related services.

There may be interconnect providers between cSEPP and pSEPP.

The interconnect provider the cSEPP's operator has a business relationship with is called cIPX (an IPX), while the interconnect provider the pSEPP's operator has a business relationship with is called pIPX (an IPX).

There could be further interconnect providers in between cIPX and pIPX, but they are assumed to be transparent and simply forward the communication.

FIG. 7 shows a schematic diagram of an example of a system environment with signaling variants, and in particular illustrates the above-outlined scenario.

The SEPPs may use Javascript Object Notation (JSON) Web Encryption (JWE) for protecting messages on e.g., an N32-f interface, and the IPX providers may use JSON Web Signatures (JWS) for signing their modifications needed for their mediation services.

For example, in a case where a service-consuming NF sends a message to a service-producing NF and this communication is across PLMN operators over the N32-f interface, as illustrated in FIG. 7, the cSEPP receives the message and applies e.g. a symmetric key based application layer protection. The resulting JWE object is forwarded to intermediaries. The pIPX and cIPX can offer services that require modifications of the messages transported over the interconnect (N32) interface. These modifications are appended to the message as digitally signed JWS objects which contain the desired changes. The pSEPP, which receives the message from pIPX, validates the JWE object, extracts the original message sent by the NF, validates the signature in the JWS object, and applies patches corresponding to the modifications by intermediaries. The pSEPP then forwards the message to the destination NF.

The N32 interface consists of:
N32-c connection, for management of the N32 interface, and
N32-f connection, for sending JWE and JWS protected messages between the SEPPs.

A possible application layer security protocol for the N32 interface is the PRotocol for N32 INterconnect Security (PRINS).

PRINS provides application layer security and enables an intermediate IPX to provide modifications to a message it forwards (describing those modifications as a patch to the original message and providing a digital signature for the modifications). The receiving SEPP can then process the requested changes to the message, as described above.

While errors may occur in the above outlined scenario or, in general, in the course of roaming and interconnect implementation, the generation, transmission, processing and handling of such errors among e.g. the involved entities, i.e., SEPPs, RIs (e.g. IPXs), and NFs, is not provided or not well specified.

Hence, there is a need to provide for error message generation and processing.

### SUMMARY

Various example embodiments aim at addressing at least part of the above issues and/or problems and drawbacks.

Various aspects of example embodiments are set out in the appended claims.

According to an exemplary aspect, there is provided a method of a first network entity associated with a first network roaming interconnected with a second network, the method comprising receiving a message indicative of a roaming service related error, wherein said message includes first error cause information related to said roaming service related error and addressed to said first network entity, and deciding on further handling of said message based on said first error cause information.

According to an exemplary aspect, there is provided a method of a second network entity involved in roaming related communication between a first network roaming interconnected with a second network and the second network, the method comprising generating a message indicative of a roaming service related error, wherein said message includes first error cause information related to said roaming service related error and addressed to a first network entity and second error cause information related to said roaming service related error and addressed to a second network entity, and transmitting said message towards said first network entity, wherein in relation to said generating, the method further comprises encrypting said first error cause information with a first encryption key.

According to an exemplary aspect, there is provided an apparatus of a first network entity associated with a first network roaming interconnected with a second network, the apparatus comprising receiving circuitry configured to receive a message indicative of a roaming service related error, wherein said message includes first error cause information related to said roaming service related error and addressed to said first network entity, and deciding circuitry configured to decide on further handling of said message based on said first error cause information.

According to an exemplary aspect, there is provided an apparatus of a second network entity involved in roaming related communication between a first network roaming interconnected with a second network and the second network, the apparatus comprising generating circuitry configured to generate a message indicative of a roaming service related error, wherein said message includes first error cause information related to said roaming service related error and addressed to a first network entity and second error cause information related to said roaming service related error and addressed to a second network entity, transmitting circuitry configured to transmit said message towards said first network entity, and encrypting circuitry configured to encrypt said first error cause information with a first encryption key.

According to an exemplary aspect, there is provided an apparatus of a first network entity associated with a first network roaming interconnected with a second network, the apparatus comprising at least one processor, and at least one memory storing instructions that, when executed by the at least one processor, cause the apparatus at least to perform receiving a message indicative of a roaming service related error, wherein said message includes first error cause information related to said roaming service related error and addressed to said first network entity, and deciding on further handling of said message based on said first error cause information.

According to an exemplary aspect, there is provided an apparatus of a second network entity involved in roaming related communication between a first network roaming interconnected with a second network and the second network, the apparatus comprising at least one processor, and at least one memory storing instructions that, when executed by the at least one processor, cause the apparatus at least to perform generating a message indicative of a roaming service related error, wherein said message includes first error cause information related to said roaming service related error and addressed to a first network entity and second error cause information related to said roaming service related error and addressed to a second network entity, and transmitting said message towards said first network entity, wherein in relation to said generating, the instructions, when executed by the at least one processor, cause the apparatus at least to perform encrypting said first error cause information with a first encryption key.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient and secure error notification handling to thereby solve at least part of the problems and drawbacks identified in relation to the prior art.

By way of example embodiments, there is provided error message generation and processing. More specifically, by way of example embodiments, there are provided measures and mechanisms for realizing error message generation and processing.

Thus, improvement is achieved by methods, apparatuses and computer program products enabling/realizing error message generation and processing.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a schematic diagram of a procedure according to example embodiments,

FIG. 6 is a schematic diagram of a procedure according to example embodiments,

FIG. 7 shows a schematic diagram of an example of a system environment with signaling variants,

FIG. 8 (FIGS. 8A and 8B) show(s) a schematic diagram of signaling sequences according to example embodiments,

FIG. 9 (FIGS. 9A and 9B) show(s) a schematic diagram of signaling sequences according to example embodiments, and

FIG. 10 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

As used herein, “at least one of the following:<a list of two or more elements>” and “at least one of<a list of two or more elements>” and similar wording, where the list of two or more elements are joined by “and” or “or”, mean at least any one of the elements, or at least any two or more of the elements, or at least all the elements.

According to example embodiments, in general terms, there are provided measures and mechanisms for (enabling/realizing) error message generation and processing.

As outlined above, while errors may occur in the course of roaming and interconnect implementation, the generation, transmission, processing and handling of errors among e.g. the involved entities, i.e., SEPPs, RIs (e.g. IPXs), and NFs, is not provided or not well specified.

Namely, as mentioned, an RI is an entity that provides roaming related services and can be a roaming hub or an IPX. An RI needs to be able to reject service-based request messages and provide appropriate information about the reason for the rejection to enable e.g. the originating SEPP to decide on a proper handling for the request and its rejection.

Further, security mechanisms are required to enable e.g. the originating SEPP to verify that the rejection and the related reason information were provided by a trusted entity.

Still further, a SEPP can receive error messages from the other SEPP, the other SEPP-adjacent RI, or the own adjacent RI. Error messages may be directly for the SEPP but could also be for the NF service consumer or NF service producer.

Hence, a receiving entity (e.g. SEPP, RI) must be also enabled to distinguish between different error messages and be able to process accordingly.

Hence, in brief, according to example embodiments, error messages originating from roaming intermediaries for 5GC interconnections are provided.

As mentioned, roaming and interconnect services are important parts of the mobile ecosystem. The roaming services infrastructure provided by the mobile operator to its subscribers typically utilizes 3^{rd} parties. IPX, RH, as well as RVAS providers make available roaming services to the MNO with efficiency and scalability. The current 5G System provides for end-to-end secure design. This design is divergent from the established 2G/3G/4G roaming ecosystem with its hop-by-hop approach via intermediaries without end-to-end security.

In the 5G system, several use cases may be foreseen for supporting subscriber roaming services by the mobile operators, e.g.
Delegation of a PLMN's SEPP to an intermediate provider (SEPP hosting), with or without a SEPP deployed in the mobile operator/PLMN;
Delegation of roaming related services (all or partial services), contractual agreements, financial liability to a trusted 3^{rd} party (e.g. RH); and
Ability to support deployment models in parallel, including the capability for the PLMN to use bi-lateral direct interconnections, delegation of SEPP functionality, and use of a 3^{rd} party to provide roaming service on a per partner PLMN basis.

While the existing services could be provided using methods (similar to 2G/3G/4G networks) in a hop-by-hop manner utilizing transport layer security (TLS), the 5^{th} Generation system (5GS) specifications do not support 3^{rd} party entities from offering the same or similar services over 5G.

Existing 3GPP service requirements and functionalities of 5G do not cover support of the mentioned specific roaming services use cases.

Namely, a requirement is that the 5G system shall allow a roaming services provider to, among others, reject registration attempts, on behalf of the involved PLMNs, based on the roaming agreements (rejecting user registrations using an appropriate release cause permits the UE to be able to reselect another roaming partner or technology).

Further, another requirement is that error messages may be originated from either PLMN SEPPs to adjacent RHs or from RHs to adjacent PLMN SEPPs, in an identifiable way.

If allowed by the PLMN policy, the SEPP shall be able to send error messages on the N32 interface to a roaming hub via the N32-f interface.

Specific error messages relevant to RHs shall be supported (such as ‘an information element (IE) is encrypted while it was expected to be available in the clear’, ‘an IE is not encrypted while its availability in the clear is not required’, ‘the N32 connection cannot be setup due to contractual reasons’, ‘the N32 connection cannot be setup due to a connectivity issue’ and ‘the message was not delivered due to contractual reasons’).

For the brief outline of example embodiments, a following use case is considered:

An N32-f security context is established, but an RI (e.g. cRI, the adjacent RI of cSEPP) rejects a request originated by cNF and processed by cSEPP.

According to example embodiments, when the RI rejects a request (originated by a NF service consumer (cNF) from the sending network and forwarded via the cSEPP towards the pSEPP), it provides a response message containing error cause information to be consumed by the cSEPP or a cNF. If it is the pRI (adjacent RI of pSEPP), the error cause information may be also consumed by cRI.

The cSEPP or cRI decides, according to example embodiments, based on the error cause information to be consumed by itself whether and how to modify the request and to resend it and/or whether and how to send the request via another route.

If the cSEPP or cRI decides not to re-send the request, according to example embodiments, it sends an error message further back to the cNF.

According to example embodiments, the RI rejecting the request provides error information for the NF consumer in addition to the error information for the cSEPP or cRI. If the cSEPP decides not to re-send the request, according to example embodiments, it removes the error cause information to be consumed by itself from the response message before forwarding the response message towards the NF consumer. Alternatively, according to example embodiments, the cSEPP modifies the error cause information to a more generic cause and removes details irrelevant for the NF consumer.

The rejecting RI may encrypt, integrity protect and/or sign the response message or parts of it in such a way that it can only be consumed by the cSEPP (e.g. by using a public key of the cSEPP for encryption and its own private key for signing).

The rejecting RI may in addition include in the response message error cause information to be consumed by another RI, e.g. cRI, and encrypt, integrity protect and/or sign it such that the error cause information can only be consumed by this cRI (e.g. by using a public key of the RI for encryption and the rejecting RI own private key for signing).

While a specific use case was considered for the above brief outline of example embodiments, example embodiments are applicable to other use cases as well, e.g.:
cRI receives information from pSEPP (possibly via pRI) and needs to report an error to its own SEPP; and
cRI could have been informed e.g. via operations, administration and maintenance (OAM), that the data volume is now limited, hence, cRI needs to provide an error to cSEPP, which may, for sufficiency, be necessary to be sent to the cNF as well.

According to example embodiments, SEPP behavior is distinguished for error handling by SEPP itself and for errors dedicated to a NF.

Example embodiments are specified below in more detail.

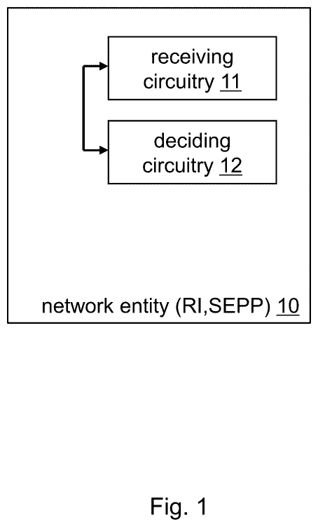

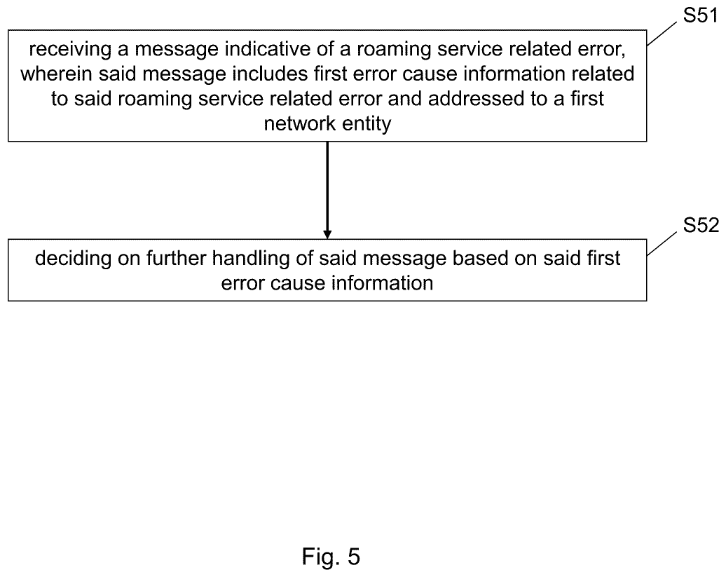

FIG. 1 is a block diagram illustrating an apparatus according to example embodiments. The apparatus may be a (first) network node or entity 10 (associated with a first network roaming interconnected with a second network) comprising a receiving circuitry 11 and a deciding circuitry 12. The receiving circuitry 11 receives a message indicative of a roaming service related error, wherein said message includes first error cause information related to said roaming service related error and addressed to said first network entity. The deciding circuitry 12 decides on further handling of said message based on said first error cause information. FIG. 5 is a schematic diagram of a procedure according to example embodiments. The apparatus according to FIG. 1 may perform the method of FIG. 5 but is not limited to this method. The method of FIG. 5 may be performed by the apparatus of FIG. 1 but is not limited to being performed by this apparatus.

As shown in FIG. 5, a procedure according to example embodiments comprises an operation of receiving (S51) a message indicative of a roaming service related error, wherein said message includes first error cause information related to said roaming service related error and addressed to said first network entity, and an operation of deciding (S52) on further handling of said message based on said first error cause information.

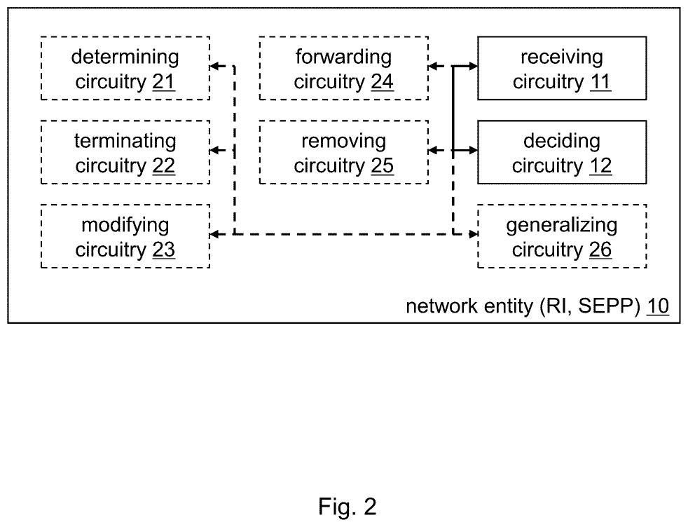

FIG. 2 is a block diagram illustrating an apparatus according to example embodiments. In particular, FIG. 2 illustrates a variation of the apparatus shown in FIG. 1. The apparatus according to FIG. 2 may thus further comprise a determining circuitry 21, a terminating circuitry 22, a modifying circuitry 23, a forwarding circuitry 24, a removing circuitry 25, and/or a generalizing circuitry 26.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 5, exemplary additional operations are given, which are inherently independent from each other as such. According to such variation, said error is related to a roaming service related request, and an exemplary method according to example embodiments may comprise an operation of deciding on further handling of said roaming service related request based on said first error cause information.

According to a variation of the procedure shown in FIG. 5, exemplary details of the deciding operation (deciding on further handling of said roaming service related request) are given, which are inherently independent from each other as such. Such exemplary deciding operation (deciding on further handling of said roaming service related request) according to example embodiments may comprise an operation of determining whether to modify and resend said roaming service related request or whether to send said roaming service related request via a different route.

According to a variation of the procedure shown in FIG. 5, exemplary details of the deciding operation (deciding on further handling of said message, S52) are given, which are inherently independent from each other as such. Such exemplary deciding operation (deciding on further handling of said message, S52) according to example embodiments may comprise an operation of terminating, if determined to modify and resend said roaming service related request or to send said roaming service related request via said different route, said message, an operation of modifying, if not determined to modify and resend said roaming service related request or to send said roaming service related request via said different route, said message as a modified message, and an operation of forwarding said modified message.

According to a variation of the procedure shown in FIG. 5, exemplary details of the modifying operation are given, which are inherently independent from each other as such. Such exemplary modifying operation according to example embodiments may comprise an operation of removing said first error cause information.

According to a variation of the procedure shown in FIG. 5, exemplary details of the modifying operation are given, which are inherently independent from each other as such. Such exemplary modifying operation according to example embodiments may comprise an operation of generalizing said first error cause information.

According to further example embodiments, said message is a roaming service related response in response to said roaming service related request.

According to further example embodiments, said first error cause information is encrypted with a first encryption key.

According to further example embodiments, said message includes second error cause information related to said roaming service related error and addressed to a second network entity.

According to further example embodiments, said second error cause information is encrypted with a second encryption key.

According to further example embodiments, said first error cause information is combined with said second error cause information.

According to further example embodiments, said message includes third error cause information related to said roaming service related error and addressed to a third network entity.

According to further example embodiments, said third error cause information is encrypted with said first encryption key.

According to further example embodiments, said third error cause information is encrypted with a third encryption key.

According to further example embodiments, said first error cause information is signed utilizing the message initiating entity's signing key. Alternatively, or in addition, according to further example embodiments, said second error cause information is signed utilizing the message initiating entity's signing key. Alternatively, or in addition, according to further example embodiments, said third error cause information is signed utilizing the message initiating entity's signing key.

According to further example embodiments, said message is a multipart message having a multipart body, and said first error cause information is included in one part of said multipart body.

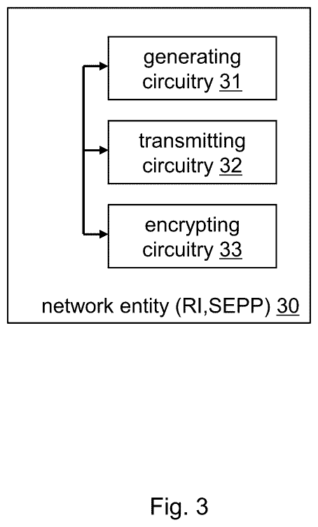

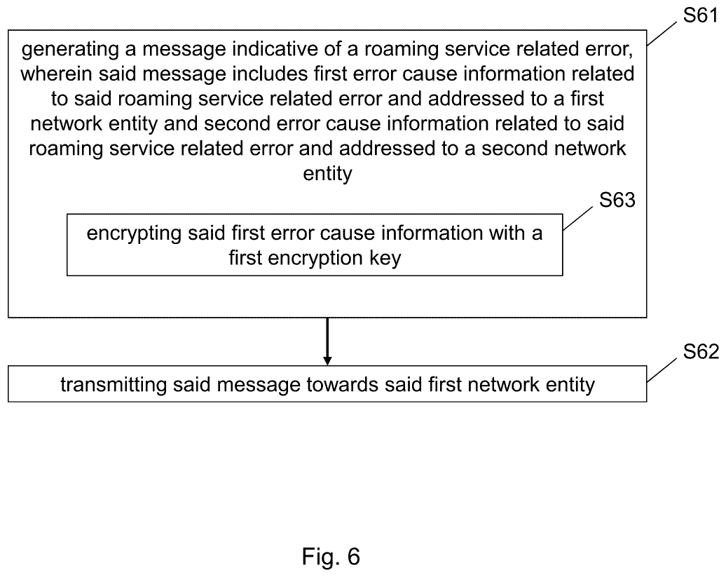

FIG. 3 is a block diagram illustrating an apparatus according to example embodiments. The apparatus may be a (second) network node or entity 30 (involved in roaming related communication between a first network roaming interconnected with a second network and the second network) comprising a generating circuitry 31, a transmitting circuitry 32, and a encrypting circuitry 33. The generating circuitry 31 generates a message indicative of a roaming service related error, wherein said message includes first error cause information related to said roaming service related error and addressed to a first network entity and second error cause information related to said roaming service related error and addressed to a second network entity. The transmitting circuitry 32 transmits said message towards said first network entity. The encrypting circuitry 33 encrypts said first error cause information with a first encryption key. FIG. 6 is a schematic diagram of a procedure according to example embodiments. The apparatus according to FIG. 3 may perform the method of FIG. 6 but is not limited to this method. The method of FIG. 6 may be performed by the apparatus of FIG. 3 but is not limited to being performed by this apparatus.

As shown in FIG. 6, a procedure according to example embodiments comprises an operation of generating (S61) a message indicative of a roaming service related error, wherein said message includes first error cause information related to said roaming service related error and addressed to a first network entity and second error cause information related to said roaming service related error and addressed to a second network entity, an operation of transmitting (S62) said message towards said first network entity, and, in relation to said generating (S61), an operation of encrypting (S63) said first error cause information with a first encryption key.

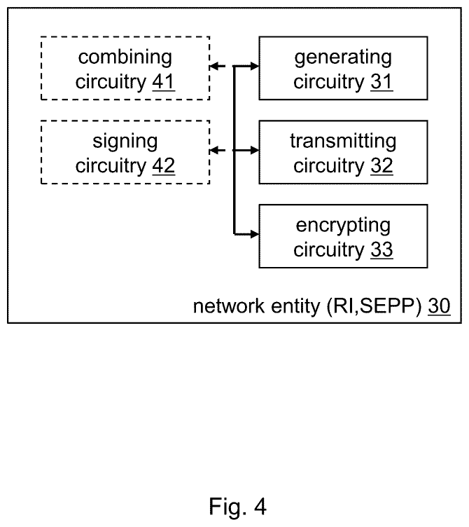

FIG. 4 is a block diagram illustrating an apparatus according to example embodiments. In particular, FIG. 4 illustrates a variation of the apparatus shown in FIG. 3. The apparatus according to FIG. 4 may thus further comprise a combining circuitry 41 and/or a signing circuitry 42.

In an embodiment at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to a variation of the procedure shown in FIG. 6, exemplary details of the generating operation (S61) are given, which are inherently independent from each other as such. Such exemplary generating operation (S61) according to example embodiments may comprise an operation of encrypting said second error cause information with a second encryption key.

According to a variation of the procedure shown in FIG. 6, exemplary details of the generating operation (S61) are given, which are inherently independent from each other as such. Such exemplary generating operation (S61) according to example embodiments may comprise an operation of combining said first error cause information with said second error cause information.

According to further example embodiments, said message includes third error cause information related to said roaming service related error and addressed to a third network entity.

According to a variation of the procedure shown in FIG. 6, exemplary details of the generating operation (S61) are given, which are inherently independent from each other as such. Such exemplary generating operation (S61) according to example embodiments may comprise an operation of encrypting said third error cause information with said first encryption key.

According to a variation of the procedure shown in FIG. 6, exemplary details of the generating operation (S61) are given, which are inherently independent from each other as such. Such exemplary generating operation (S61) according to example embodiments may comprise an operation of encrypting said third error cause information with a third encryption key.

According to a variation of the procedure shown in FIG. 6, exemplary details of the generating operation (S61) are given, which are inherently independent from each other as such. Such exemplary generating operation (S61) according to example embodiments may comprise an operation of signing said first error cause information utilizing an own signing key. Alternatively, or in addition, such exemplary generating operation (S61) according to example embodiments may comprise an operation of signing said second error cause information utilizing said own signing key. Alternatively, or in addition, such exemplary generating operation (S61) according to example embodiments may comprise an operation of signing said third error cause information utilizing said own signing key.

According to further example embodiments, said error is related to a roaming service related request, and said message is a roaming service related response in response to said roaming service related request.

According to further example embodiments, said message is a multipart message having a multipart body, and said first error cause information is included in one part of said multipart body.

Example embodiments outlined and specified above are explained below in more specific terms.

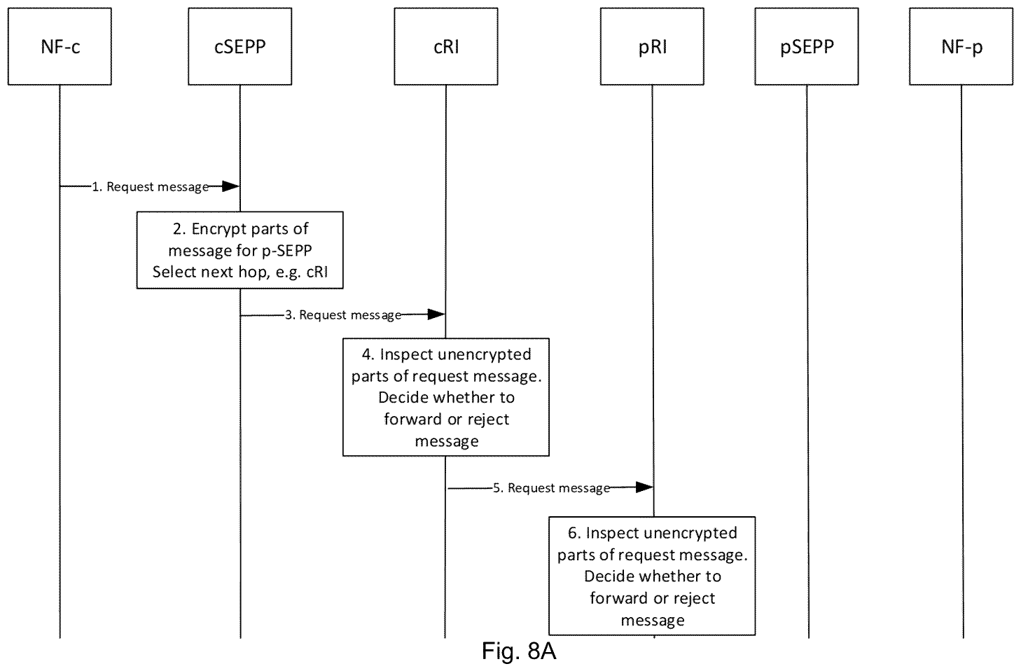

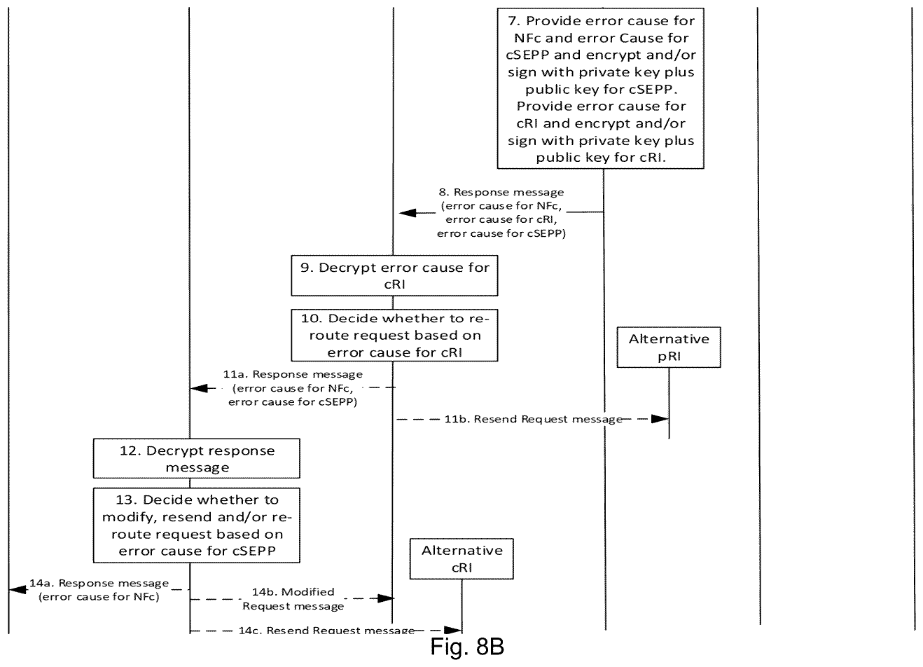

FIG. 8 (FIGS. 8A and 8B) show(s) a schematic diagram of signaling sequences according to example embodiments, and in particular illustrates an example of a call flow for rejection by pRI according to example embodiments. Here, FIG. 8B represents continuation of FIG. 8A.

As illustrated in FIG. 8, in a step 1 of FIG. 8, an NFc transmits a request message to(wards) a cSEPP.

In a step 2 of FIG. 8, the cSEPP encrypts parts of the request message for pSEPP and selects next hop, e.g. cRI.

In a step 3 of FIG. 8, the cSEPP transmits the request message to(wards) the cRI.

In a step 4 of FIG. 8, the cRI inspects unencrypted parts of request message, and decides whether to forward or reject the message.

In a step 5 of FIG. 8, the cRI transmits the request message to(wards) a pRI.

In a step 6 of FIG. 8, the pRI inspects unencrypted parts of request message, and decides whether to forward or reject the message.

In a step 7 of FIG. 8, according to example embodiments, the pRI decides to reject the message. According to example embodiments, the pRI provides an error cause for the NFc and an error cause for the cSEPP and encrypts and/or signs with private key plus public key for cSEPP. According to example embodiments, the pRI provides an error cause for the cRI and encrypts and/or signs with private key plus public key for cRI.

In a step 8 of FIG. 8, according to example embodiments, the pRI transmits a response message (error cause for NFc, error cause for cRI, error cause for cSEPP) to(wards) the cRI.

In a step 9 of FIG. 8, according to example embodiments, the cRI decrypts the error cause for the cRI.

In a step 10 of FIG. 8, according to example embodiments, the cRI decides whether to re-route the request based on the error cause for the cRI.

In a step 11b of FIG. 8, according to example embodiments, once decided to re-route the request, the cRI resends the request message to(wards) an alternative pRI.

In a step 11a of FIG. 8, according to example embodiments, e.g. once decided not to re-route the request, the cRI transmits a response message (error cause for NFc, error cause for cSEPP) to(wards) the cSEPP.

In a step 12 of FIG. 8, according to example embodiments, the cSEPP decrypts the response message.

In a step 13 of FIG. 8, according to example embodiments, the cSEPP decides whether to modify, resend and/or re-route the request based on the error cause for the cSEPP.

In a step 14b of FIG. 8, according to example embodiments, once decided to modify and resend the request, the cSEPP transmits the modified request message to(wards) the cRI.

In a step 14c of FIG. 8, according to example embodiments, once decided to re-route the request, the cSEPP transmits the request message to(wards) an alternative cRI.

In a step 14a of FIG. 8, according to example embodiments, once decided not to modify, resend, and re-route the request, the cSEPP transmits a response message (error cause for NFc) to(wards) the NFC.

According to example embodiments, the error cause information to be consumed by the cRI and the error cause information to be consumed by the cSEPP can be combined or can be provided separately (if separate encryption and/or signature is required, as shown in FIG. 8).

According to example embodiments, the error cause information for the NFc can be provided separately.

According to example embodiments, the error cause information for the NFc follows the existing HTTP encoding for the 5GC (with HTTP response status code and problem details), and the error cause information for the cSEPP or cRI may apply a new encoding such as a (new) dedicated HTTP header or an HTTP body of a dedicated type (possibly as one part of a multipart body if other HTTP bodies are also required) (step 8 of FIG. 8).

According to example embodiments, error cause information that can be consumed by both a cSEPP and cRI can include information such as ‘the N32 connection cannot be setup due to contractual reasons’, ‘the N32 connection cannot be setup due to a connectivity issue’, and ‘the message was not delivered due to contractual reasons’. According to example embodiments, a cSEPP or cRI can re-send the message via an alternative RI (cRI or pRI, respectively) when receiving such an error code, if a suitable alternative RI is available (step 7, step 10, step 11b, step 13, step 14c of FIG. 8).

According to example embodiments, the pRI derives an NFc error cause information from a more specific error for cSEPP: The pRI modifies the error cause information for the cSEPP to a more generic cause and removes details irrelevant for the NF consumer. According to example embodiments, the pRI uses the class default HTTP status code instead of more specific status codes (e.g. 400 instead of other 4xx codes) (step 7 of FIG. 8).

According to example embodiments, the cRI removes the error cause information for the cRI when forwarding the error response to the cSEPP (step 11 of FIG. 8).

According to example embodiments, error cause information that can be consumed by a cSEPP can also include information such as ‘an IE is encrypted while it was expected to be available in the clear’, ‘an IE is not encrypted while its availability in the clear is not required’. According to example embodiments, the cSEPP can then modify the encryption of the request message accordingly, if this is permissible according to its policies (step 7, step 10, step 13, step 14b of FIG. 8).

According to example embodiments, the cSEPP removes the error cause information for the cSEPP when forwarding the error response to the NFc (step 14a of FIG. 8).

According to example embodiments, the cSEPP modifies the error cause information to a more generic cause and removes details irrelevant for the NF consumer. According to example embodiments, the cSEPP uses the class default HTTP status code instead of more specific status codes (e.g. 400 instead of other 4xx codes).

Specific example embodiments covered by what is outlined, specified, and explained above may be precisely defined as follows.

In particular, message verification by a receiving SEPP may be precisely defined as follows.

The receiving SEPP shall decrypt the JWE ciphertext using the shared session key and the following parameters obtained from the JWE object
Initialization Vector, Additional Authenticated Data value (clearTextEncapsulatedMessage in “aad”) and JWE Authentication Tag (“tag”).

If the reformattedData IE is not empty, the receiving SEPP shall check the integrity and authenticity of the clearTextEncapsulatedMessage and the encrypted text by verifying the JWE Authentication Tag in the JWE object with the JWE AAD algorithm. The algorithm returns the decrypted plaintext (dataToIntegrityProtectAndCipher) only if the JWE Authentication Tag is correct.

The receiving SEPP refers to the NF API data-type placement mapping table to re-construct the original reformatted message by updating corresponding entries in clearTextEncapsulatedMessage with values in the dataToIntegrityProtectAndCipher array.

The receiving SEPP shall next verify IPX provider updates, if included, by verifying the JWS signatures added by the Roaming Intermediaries. The SEPP shall verify the JWS signature, using the corresponding raw public key or certificate that is contained in the IPX provider's security information list obtained during parameter exchange in the related N32-c connection setup or, alternatively, has been configured for the particular peer SEPP. If the reformattedData IE is not empty, the receiving SEPP shall then check that the raw public key or certificate of the JWS signature IPX's Identity in the modifiedDataToIntegrity block matches to the IPX provider referred to in the “authorizedIPX ID” field added by the sending SEPP, based on the information given in the IPX provider security information list. If the reformattedData IE is empty, the receiving SEPP shall check that the raw public key or certificate of the JWS signature IPX's identity in the modifiedDataToIntegrityProtect block matches to the adjacent roaming hub in the N32-f security context extracted from defined modifiedDataToIntegrityProtect block, of the first roaming hub.

The receiving SEPP shall check whether the modifications performed by the Roaming Intermediaries were permitted by the respective modification policies. The receiving SEPP shall use the modification policy of the cIPX obtained during parameter exchange in the related N32-c connection setup, and use the modification policy of pIPX configured within the receiving SEPP.

If this is the case, the receiving SEPP shall apply the patches in the Operations field in order, perform plausibility checks, and create a new HTTP request according to the “patched” clearTextEncapsulatedMessage.

The receiving SEPP shall verify that the PLMN-ID contained in the incoming N32-f message matches the PLMN-ID in the related N32-f context.

Further, handling of roaming intermediary's initiated errors by the SEPP may be precisely defined as follows.

A SEPP receiving an error message originated by a Roaming Intermediary shall be able to determine if the error information received relates to itself or is for further processing by the NF. Different error causes are necessary.

If the SEPP determines that an error message or parts of the error message need to be provided to a NF, it takes appropriate actions for further processing. E.g., in case of error messages in response to a registration request the payload is not necessarily empty and may need to be differently encoded for the NF. Error information addressed to the SEPP and irrelevant to the NF can be removed in this case.

If the SEPP determines that another Roaming Intermediary needs to be addressed, it sends the request message to an alternative Roaming Intermediary.

If the SEPP determines from the error code that the Roaming Intermediary requires a modified request message, it can modify accordingly and resend the modified request message.

Error messages from one Roaming Intermediary not adjacent to a SEPP to the Roaming Intermediary adjacent to the SEPP may also affect this SEPP.

Error messages shall be integrity protected and signed by the Roaming Intermediary.

Further, a message flow between the two SEPPs with modifications from cIPX and pIPX may be precisely defined as follows.

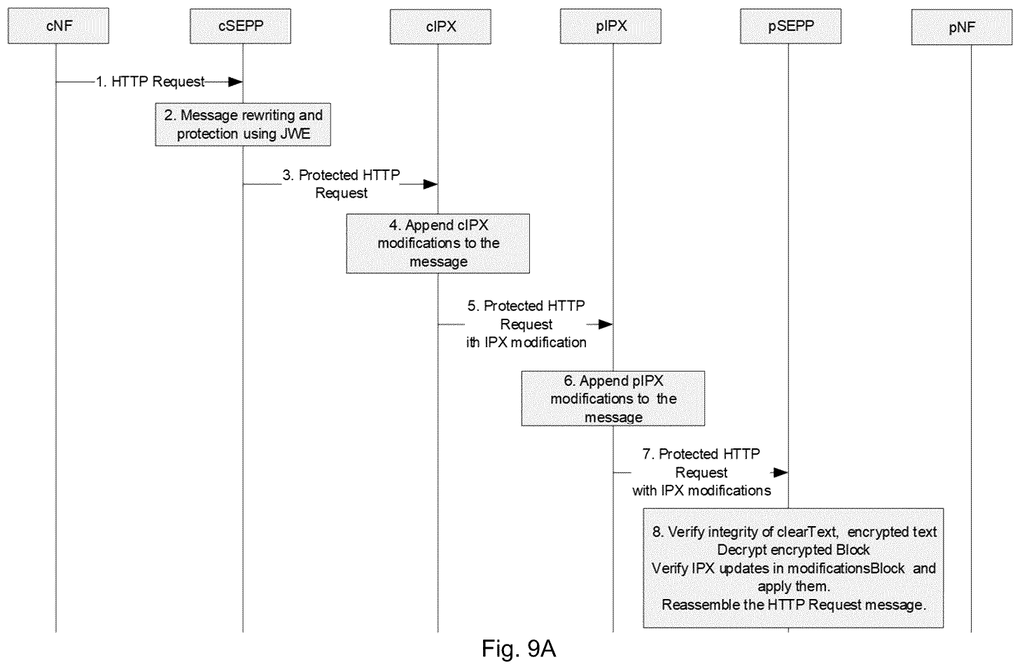

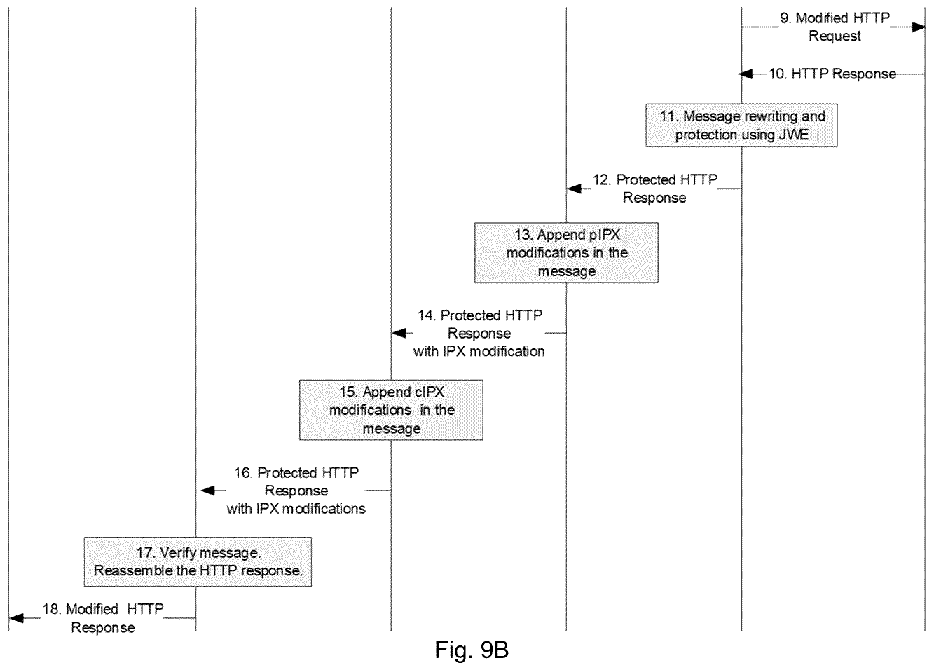

FIG. 9 (FIGS. 9A and 9B) show(s) a schematic diagram of signaling sequences according to example embodiments, and in particular illustrates the message flow between the two SEPPs with modifications from cIPX and pIPX. Here, FIG. 9B represents continuation of FIG. 9A.

Step 1 of FIG. 9: The cSEPP receives an HTTP request message from a network function. If the message contains a telescopic FQDN, the cSEPP removes its domain name from this FQDN to obtain the original FQDN.

Step 2 of FIG. 9: The cSEPP shall reformate the HTTP Request message as follows:
a. The cSEPP shall generate blocks (JSON objects) for integrity protected data and encrypted data, and protecting them:

The cSEPP shall encapsulate the HTTP request into a clearTextEncapsulatedMessage block containing the following child JSON objects:
Pseudo_Headers.
HTTP_Headers with one element per header of the original request.
Payload that contains the message body of the original request. For each attribute that requires end-to-end encryption between the two SEPPs, the attribute value is copied into a dataToIntegrityProtectAndCipher JSON object and the attribute's value in the clearTextEncapsulatedMessage is replaced by the index of attribute value in the dataToIntegrityProtectAndCipher block.

The cSEPP shall create a metadata block that contains the N32-f context ID, message ID generated by the cSEPP for this request/response transaction and next hop identity.

The cSEPP shall protect the dataToIntegrityProtect block and the dataToIntegrityProtectAndCipher block. This results in a single JWE object representing the protected HTTP Request message.
b. The cSEPP shall generate payload for the SEPP to SEPP HTTP message:

The JWE object becomes the payload of the new HTTP message generated by cSEPP.

Step 3 of FIG. 9: The cSEPP shall use HTTP POST to send the HTTP message to the first Roaming Intermediary.

Step 4 of FIG. 9: The first Roaming Intermediary (e.g. visited network's IPX provider) shall create a new modifiedDataToIntegrityProtect JSON object with three elements:
a. The Operations JSON patch document contains modifications performed by the first Roaming Intermediary as per RFC 6902.
b. The first Roaming Intermediary shall include its own identity in the Identity field of the modifiedDataToIntegrityProtect.
c. The first Roaming Intermediary shall copy the “tag” element, present in the JWE object generated by the cSEPP, into the modifiedDataToIntegrityProtect object. This acts as a replay protection for updates made by the first Roaming Intermediary.

The Roaming Intermediary shall execute JWS on the modifiedDataToIntegrityProtect JSON object and append the resulting JWS object to the message.

Step 5 of FIG. 9: The first Roaming Intermediary shall send the modified HTTP message request to the second Roaming Intermediary (e.g. home network's IPX) as in step 3 of FIG. 9.

Step 6 of FIG. 9: The second Roaming Intermediary shall perform further modifications as in step 4 of FIG. 9 if required. The second Roaming Intermediary shall further execute JWS on the modifiedDataToIntegrityProtect JSON object and shall append the resulting JWS object to the message.

Step 7 of FIG. 9: The second Roaming Intermediary shall send the modified HTTP message to the pSEPP as in step 3 of FIG. 9.

The behaviour of the Roaming Intermediaries is not normative, but the pSEPP assumes that behaviour for processing the resulting request.

Step 8 of FIG. 9: The pSEPP receives the message and shall perform the following actions:
The pSEPP extracts the serialized values from the components of the JWE object.
The pSEPP invokes the JWE AEAD algorithm to check the integrity of the message and decrypt the dataToIntegrityProtectAndCipher block. This results in entries in the encrypted block becoming visible in cleartext.
The pSEPP updates the clearTextEncapsulationMessage block in the message by replacing the references to the dataToIntegrityProtectAndCipher block with the referenced decrypted values from the dataToIntegrityProtectAndCipher block.
The pSEPP then verifies IPX provider updates of the attributes in the modificationsArray. It checks whether the modifications performed by the Roaming Intermediaries were permitted by policy.

The pSEPP further verifies that the PLMN-ID contained in the message is equal to the “Remote PLMN-ID” in the related N32-f context.
The pSEPP updates the modified values of the attributes in the clearTextEncapsulationMessage in order.

The pSEPP shall re-assemble the full HTTP Request from the contents of the clearTextEncapsulationMessage.

Step 9 of FIG. 9: The pSEPP shall send the HTTP request resulting from step 8 to the home network's NF.

Step 10 to 18 of FIG. 9: These steps are analogous to steps 1 to 9 of FIG. 9.

Further, a message flow between two SEPPs for error handling in case of rejection of request message by a Roaming Intermediary (RI) may be precisely defined as illustrated in FIG. 8.

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network node or entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

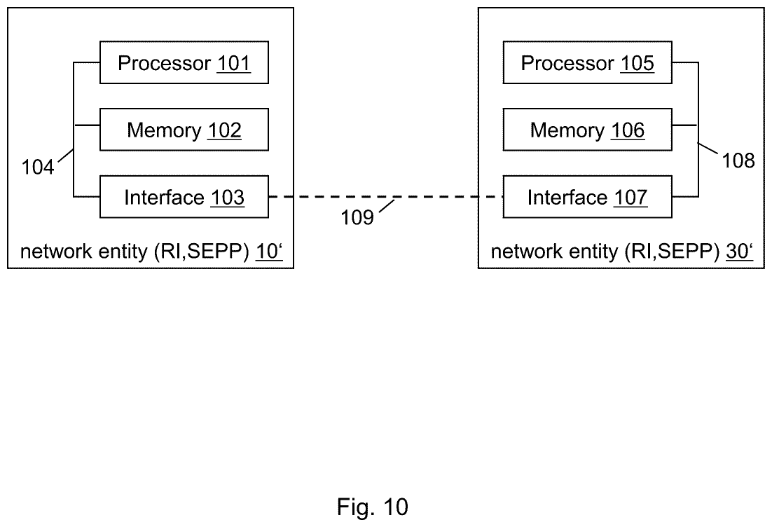

In FIG. 10, an alternative illustration of apparatuses according to example embodiments is depicted. As indicated in FIG. 10, according to example embodiments, the apparatus (network node or entity) 10′ (corresponding to the network node or entity 10) comprises a processor 101, a memory 102 and an interface 103, which are connected by a bus 104 or the like. Further, according to example embodiments, the apparatus (network node or entity) 30′ (corresponding to the network node or entity 30) comprises a processor 105, a memory 106 and an interface 107, which are connected by a bus 108 or the like, and the apparatuses may be connected via link 109, respectively.

The processor 101/105 and/or the interface 103/107 may also include a modem or the like to facilitate communication over a (hardwire or wireless) link, respectively. The interface 103/107 may include a suitable transceiver coupled to one or more antennas or communication means for (hardwire or wireless) communications with the linked or connected device(s), respectively. The interface 103/107 is generally configured to communicate with at least one other apparatus, i.e. the interface thereof.

The memory 102/106 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the network node or entity 10 (of a first network entity associated with a first network roaming interconnected with a second network) comprises at least one processor 101, at least one memory 102 including computer program code, and at least one interface 103 configured for communication with at least another apparatus. The processor (i.e. the at least one processor 101, with the at least one memory 102 and the computer program code) is configured to perform receiving a message indicative of a roaming service related error, wherein said message includes first error cause information related to said roaming service related error and addressed to said first network entity (thus the apparatus comprising corresponding means for receiving), and to perform deciding on further handling of said message based on said first error cause information (thus the apparatus comprising corresponding means for deciding).

According to example embodiments, an apparatus representing the network node or entity 30 (a second network entity involved in roaming related communication between a first network roaming interconnected with a second network and the second network) comprises at least one processor 105, at least one memory 106 including computer program code, and at least one interface 107 configured for communication with at least another apparatus. The processor (i.e. the at least one processor 105, with the at least one memory 106 and the computer program code) is configured to perform generating a message indicative of a roaming service related error, wherein said message includes first error cause information related to said roaming service related error and addressed to a first network entity and second error cause information related to said roaming service related error and addressed to a second network entity (thus the apparatus comprising corresponding means for generating), to perform transmitting said message towards said first network entity (thus the apparatus comprising corresponding means for transmitting), and to perform, in relation to said generating, encrypting said first error cause information with a first encryption key (thus the apparatus comprising corresponding means for encrypting).

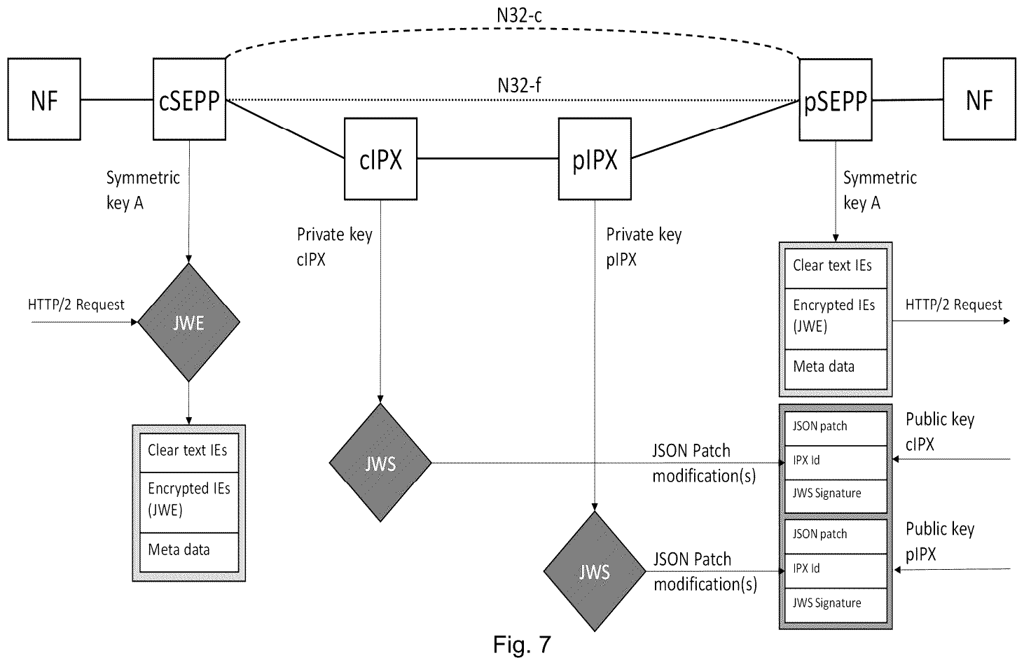

For further details regarding the operability/functionality of the individual apparatuses, reference is made to the above description in connection with any one of FIGS. 1 to 9, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for error message generation and processing. Such measures exemplarily comprise, at a first network entity associated with a first network roaming interconnected with a second network, receiving a message indicative of a roaming service related error, wherein said message includes first error cause information related to said roaming service related error and addressed to said first network entity, and deciding on further handling of said message based on said first error cause information.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP 3rd Generation Partnership Project
5G 5th Generation
5GC 5th Generation core
5GS 5th Generation system
c-RI, cRI consumer's RI
c-SEPP, cSEPP consumer's SEPP
IE information element
IP internet protocol
IPX IP interconnect exchange, IP exchange service
JSON JavaScript Object Notation
JWE JSON Web Encryption
JWS JSON Web Signatures
MNO mobile network operator
NF network function
NF-c, NFc Network function consumer
NF-p, NFp Network function producer
OAM operations, administration and maintenance
PLMN public land mobile network
PRINS PRotocol for N32 INterconnect Security
p-RI, pRI producer's RI
p-SEPP, pSEPP producer's SEPP
RH roaming hub
RI roaming intermediary
RVAS roaming value-added service
SA stand-alone
SEPP security edge protection proxy
TLS transport layer security

1. An apparatus of a first network entity associated with a first network roaming interconnected with a second network, the apparatus comprising
at least one processor, and
at least one memory storing instructions that, when executed by the at least one processor, cause the apparatus at least to perform:
receiving a message indicative of a roaming service related error, wherein said message includes first error cause information related to said roaming service related error and addressed to said first network entity, and
deciding on further handling of said message based on said first error cause information.

2. The apparatus according to claim 1, wherein
said error is related to a roaming service related request, and the instructions, when executed by the at least one processor, cause the apparatus at least to perform:
deciding on further handling of said roaming service related request based on said first error cause information.

3. The apparatus according to claim 2, wherein
in relation to said deciding on further handling of said roaming service related request, the instructions, when executed by the at least one processor, cause the apparatus at least to perform:
determining whether to modify and resend said roaming service related request or whether to send said roaming service related request via a different route, and
in relation to said deciding on further handling of said message, the instructions, when executed by the at least one processor, cause the apparatus at least to perform:
terminating, if determined to modify and resend said roaming service related request or to send said roaming service related request via said different route, said message, and
modifying, if not determined to modify and resend said roaming service related request or to send said roaming service related request via said different route, said message as a modified message, and
forwarding said modified message.

4. The apparatus according to claim 3, wherein
in relation to said modifying said message, the instructions, when executed by the at least one processor, cause the apparatus at least to perform:
removing said first error cause information, or
generalizing said first error cause information.

5. The apparatus according to claim 2, wherein
said message is a roaming service related response in response to said roaming service related request.

6. The apparatus according to claim 1, wherein
said first error cause information is encrypted with a first encryption key.

7. The apparatus according to claim 6, wherein
said message includes second error cause information related to said roaming service related error and addressed to a second network entity, and optionally
said second error cause information is encrypted with a second encryption key.

8. The apparatus according to claim 7, wherein
said first error cause information is combined with said second error cause information.

9. The apparatus according to claim 6, wherein
said message includes third error cause information related to said roaming service related error and addressed to a third network entity.

10. The apparatus according to claim 9, wherein
said third error cause information is encrypted with said first encryption key, or
said third error cause information is encrypted with a third encryption key.

11. The apparatus according to claim 9, wherein at least one of the following:
said first error cause information is signed utilizing the message initiating entity's signing key, or
said second error cause information is signed utilizing the message initiating entity's signing key, or
said third error cause information is signed utilizing the message initiating entity's signing key.

12. The apparatus according to claim 1, wherein
said message is a multipart message having a multipart body, and
said first error cause information is included in one part of said multipart body.

13. An apparatus of a second network entity involved in roaming related communication between a first network roaming interconnected with a second network and the second network, the apparatus comprising
at least one processor, and
at least one memory storing instructions that, when executed by the at least one processor, cause the apparatus at least to perform:
generating a message indicative of a roaming service related error, wherein said message includes first error cause information related to said roaming service related error and addressed to a first network entity and second error cause information related to said roaming service related error and addressed to a second network entity, and
transmitting said message towards said first network entity, wherein
in relation to said generating, the instructions, when executed by the at least one processor, cause the apparatus at least to perform:
encrypting said first error cause information with a first encryption key.

14. The apparatus according to claim 13, wherein
in relation to said generating, the instructions, when executed by the at least one processor, cause the apparatus at least to perform:
encrypting said second error cause information with a second encryption key.

15. The apparatus according to claim 13, wherein
in relation to said generating, the instructions, when executed by the at least one processor, cause the apparatus at least to perform:
combining said first error cause information with said second error cause information.

16. The apparatus according to claim 13, wherein
said message includes third error cause information related to said roaming service related error and addressed to a third network entity.

17. The apparatus according to claim 16, wherein
in relation to said generating, the instructions, when executed by the at least one processor, cause the apparatus at least to perform:
encrypting said third error cause information with said first encryption key, or
encrypting said third error cause information with a third encryption key.

18. The apparatus according to claim 16, wherein
in relation to said generating, the instructions, when executed by the at least one processor, cause the apparatus at least to perform at least one of the following:
signing said first error cause information utilizing an own signing key, or
signing said second error cause information utilizing said own signing key, or
signing said third error cause information utilizing said own signing key.

19. The apparatus according to claim 13, wherein
said error is related to a roaming service related request, and
said message is a roaming service related response in response to said roaming service related request.

20. The apparatus according to claim 13, wherein
said message is a multipart message having a multipart body, and
said first error cause information is included in one part of said multipart body.
